(19) United States
(12) Patent Application Publication
(10) Pub. No.: US 2009/0007128 A1
(43) Pub. Date: Jan. 1, 2009

(54) METHOD AND SYSTEM FOR ORCHESTRATING SYSTEM RESOURCES WITH ENERGY CONSUMPTION MONITORING

(75) Inventors: Stefano Borghetti, Rome (IT); Leonida Gianfagna, Rome (IT); Antonio Mario Sgro, Girifalco (IT)

Correspondence Address: IBM CORPORATION;INTELLECTUAL PROPERTY LAW, 11501 BURNET ROAD, AUSTIN, TX, 78758, US

(73) Assignee: International Business Machines Corporation, Armonk, NY (US)

(21) Appl. No.: 12/147,855

(22) Filed: Jun. 27, 2008

(30) Foreign Application Priority Data
Jun. 28, 2007 (EP) 07111230.4

(51) Int. Cl. G06F 9/46

(52) U.S. Cl. 718/104

(57) ABSTRACT

A method and system for orchestrating system resources including provisioning process, performance measurement, capacity planning and infrastructure deployment. An integrated solution is provided which could help monitoring the system power consumption and applying corrective rebalancing actions. Such orchestrating and rebalancing activity is performed by the system taking into account the estimated power consumption of the single SW applications.

### FIELD OF THE INVENTION

The present invention relates to the data processing field. More specifically, the present invention relates to methods and systems for system resource balancing with energy consumption monitoring in a data processing system. The invention further relates to a computer program for performing the method, and to a product embodying the program. Moreover, the invention also relates to a corresponding apparatus.

### BACKGROUND ART

A critical issue in complex IT environments is the power consumption of hardware components and possible thermal and reliability problems which can be caused if not properly monitored and managed. Also energy saving requirements should be taken into account, due to environmental impact and to increasing costs. Furthermore, risks and costs related to energy supply interruption (blackout) caused by high consume and excessive request by the users must be taken into account. In a data processing system it is known to monitor the consumption of the single devices and to apply some correction actions in order to optimize the total power consumption of a data processing system. E.g. U.S. Pat. No. 7,197,652 discloses a method for energy management in a multi-thread data processing system. The method provides per-device usage evaluators within performance monitor units which monitor the use of connected devices. However power consumption can depend also on the way the devices are used, i.e. it can depend on the software applications being run on the system and on the SW and HW resources used by the applications. State of the art methods and systems do not provide an integrated monitoring and provisioning solution which is able to manage and balance system resources also in view of the energy consumption of the system.

An integrated solution which could help monitoring the system power consumption and applying corrective rebalancing actions would therefore be highly appreciated.

It is an object of the present invention to provide a method and a system which alleviates the above drawbacks.

### SUMMARY OF THE INVENTION

According to the present invention we provide a method of provisioning resources in a data processing system including a plurality of resources, each resource having a predefined data sheet defining an expected power usage, the method including the steps of: monitoring the activities of at least one software application running on the data processing system, the at least one software application using at least one of the plurality of resources; tracking any use of each at least one resource made by the at least one software application; estimating the power usage of the at least one software application according to the tracked use and the associated expected power usage; comparing the estimated power usage to a predetermined thresholds; responsive to the predetermined thresholds being exceeded re-balancing the provisioning of the system resources.

Another aspect of the present invention provides a computer program for performing the above-described method.

A still further aspect of the invention provides a program product embodying this program.

Moreover, another aspect of the invention provides a corresponding apparatus for implementing the above method.

The novel features believed to be characteristic of this invention are set forth in the appended claims. The invention itself, however, as well as these and other related objects and advantages thereof, will be best understood by reference to the following detailed description to be read in conjunction with the accompanying drawings.

### BRIEF DESCRIPTION OF THE DRAWINGS

FIG. 1 is a schematic block diagram of a data processing system in which the method of the invention is applicable;

FIG. 2 shows the functional blocks of a generic computer of the system;

FIG. 3 depicts the main components that can be used for practicing the method; and

FIG. 4 shows a diagram describing the flow of activities relating to an illustrative implementation of the method.

### DETAILED DESCRIPTION OF THE PREFERRED EMBODIMENT(S)

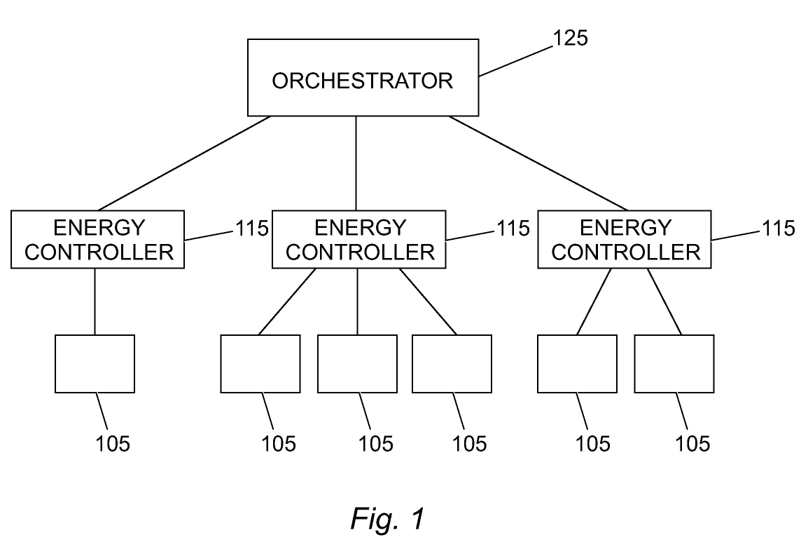

With reference in particular to FIG. 1, a data processing system is depicted. The system includes a plurality of resources 105 which can be grouped in a plurality of subsets each one being controlled by an Energy Controller 115. The resources 105 can be storage devices, CPUs, graphic cards, hard disks and more generally any kind of system resource which cause a power usage during execution of a SW process. The resources 105 communicate with a system Energy Controller 115 which collects information about resources activity through system API (i.e. via software), e.g. CPU usage per process or disk read/write per process. Energy Controller 115 implements a central repository where consumption data of the related resources are collected and managed. The Energy Controller 115 communicate with a central Orchestrator 125 which manages the whole system, including provisioning process, performance measurement and capacity planning. The present invention may be implemented in a Orchestrator Product e.g. IBM Tivoli Intelligent Orchestrator system, but more generally in any system implementing system monitoring activities, e.g. Novell ZENworks Orchestrator. Generally, an orchestrator is a powerful solution that can help improve service levels by constantly monitoring resources and requirements for anticipated peak workloads and then triggering the appropriate response based on your business priorities; it increases IT resource utilization tied directly to business results. Orchestration allows companies to manipulate their IT environment in real time—according to defined business policies—to achieve desired business goals. Orchestration does this by sensing the increase or decrease in IT resource demand and automatically taking action to reallocate resources accordingly throughout the entire system, allowing multiple applications to be efficiently run according to business priorities on a common, dynamic, intelligently managed IT infrastructure. It can also anticipate plans and dynamically provides server capacity to meet peak business needs on demand.

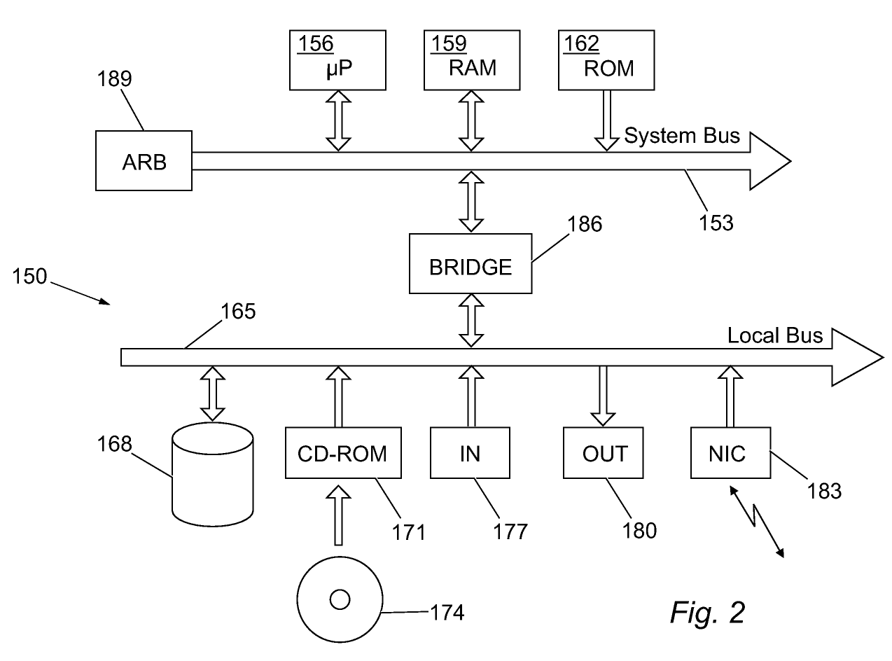

As shown in FIG. 2, a generic computer of the system (workstations, local server, or peripherals) is denoted with 150. The computer 150 is formed by several units that are connected in parallel to a system bus 153. In detail, one or more microprocessors (μP) 156 control operation of the computer 150; a RAM 159 is directly used as a working memory by the microprocessors 156, and a ROM 162 stores basic code for a bootstrap of the computer 150. Peripheral units are clustered around a local bus 165 (by means of respective interfaces). Particularly, a mass memory consists of a hard-disk 168 and a drive 171 for reading CD-ROMs 174. Moreover, the computer 150 includes input devices 177 (for example, a keyboard and a mouse), and output devices 180 (for example, a monitor and a printer). A Network Interface Card (NIC) 183 is used to connect the computer 150 to the network. A bridge unit 186 interfaces the system bus 153 with the local bus 165. Each microprocessor 156 and the bridge unit 186 can operate as master agents requesting an access to the system bus 153 for transmitting information. An arbiter 189 manages the granting of the access with mutual exclusion to the system bus 153.

Similar considerations apply if the system has a different topology, or it is based on other networks. Alternatively, the computers have a different structure, include equivalent units, or consist of other data processing entities (such as PDAs, mobile phones, and the like). In any case, the solution of the invention is also suitable to be used in a system wherein the control of the workstations is decentralized, or even in a stand-alone computer.

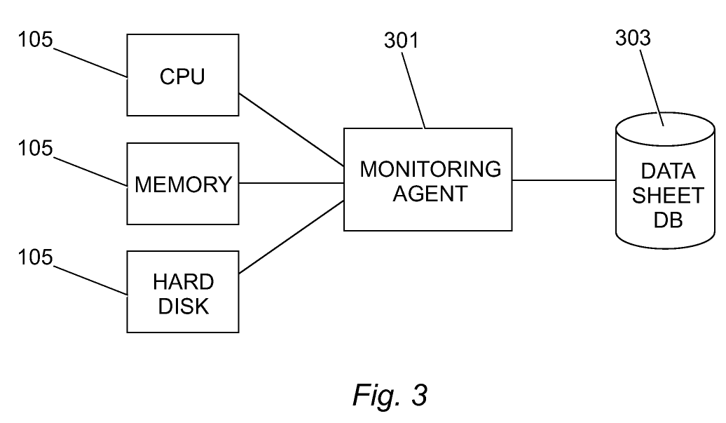

Considering now FIG. 3, the main components that can be used to practice the method of a preferred embodiment of the invention are illustrated. The information (programs and data) is typically stored on the hard-disks of the different computers and loaded (at least partially) into the corresponding working memories when the programs are running.

In FIG. 3 it is considered one Energy Controller 115 (see FIG. 1) with three exemplary resources attached; a CPU, a Memory and a Hard Disk. A Monitoring Agent 301 controls and executes monitoring operations on several resources 105, connected by a communication network. The set of possible resources 105 includes e.g. hard disks, CPUs, memories, network cards, printers, backup devices, whose consumption is stored in repository 303 which contains all information available on each monitored resource. This information is normally available through devices data sheet provided by device manufacturer.

The monitoring Agent 301 controls a potentially large set of resources 105, but in FIG. 3 only three resources (a CPU, a Memory and a hard disk) are represented. The monitoring agent 301 monitors the usage of resources per process. Then the monitoring agents 301 looks on the data sheet repository 303 where an estimate of the consumption for each activity is stored: putting together the two measures an expected consumption of the resource is estimated. According to a preferred embodiment of the present invention, repository 303 contains values which are obtained from manufacturers energy consumption data sheets which are to be combined with the usage metrics collected by Monitoring Agent 115 in order to obtain the final energy consumption estimate; however other possible solution are available: e.g. the values stored could be the results of historical measurement which have been stored for future reuse. According to a preferred embodiment of the present invention, the above data gathering method is implemented by using IBM Tivoli Monitoring product; it is however understood by those skilled in the art that other systems, producing similar results could be used instead.

In a preferred embodiment of the present invention a new feature is inserted in a system availability monitoring product which estimates the power consumption of the system starting from the measurement of some parameters collected by the IBM Tivoli Monitoring tools. State of the art monitoring products do not provide integrated solutions which are able to effectively monitor power and energy consumption. All systems are impacted by energy consumption, by the usage of its resources (hard-disk, CPU, memory, CD-ROM, etc.); when the usage of these components increases, the energy consumption increases too. The usage of the above components can be calculated through Monitoring tool according to some specific parameters. According to a preferred embodiment of the present invention Data Base 303 contains information on the average consumption of each resource. An example table sheet is the following:

| RESOURCE | AVERAGE CONSUMPTION |
|---|---|
| CPU | 0.5 W |
| Memory | 0.005 W per Kbyte |
| Hard Disk | 1 W |

According to our example let's suppose Monitoring Agent 301 meters the following values:

Total duration of a SW Application (LifeTime)=3600 sec;

Total used CPU time (CPUtime)=1000 sec;

Average Memory used (AvgMem)=300 Kbyte

Total Disk usage (DiskUsg)=300 sec

We have the following estimated consumption:

EnergyCons=(CPU*CPUtime+AvgMem*Mem*LifeTime+Disk*DiskUsg)/LifeTime=W(0.5*1000+300*0.005*3600+1*300)/3600=1.72 W

The calculation above has been done using an average of the expected consumption of each resource. A more complex estimate could be used instead. E.g. the calculated metrics of the usage could be based on the measurement of the time during which a resource is in a predetermined status. Each resource has an associated table, determining the expected power consumption according to the status. A typical table describing a resource (e.g. a hard disk) could be the following:

| STATUS | EXPECTED POWER (W) |
|---|---|
| 1 Sleep | 0.15 |
| 2 Idle | 1.6 |
| 3 Standby | 0.35 |
| 4 Active | 3.2 |
| 5 Seeking | 4.1 |
| 6 Spin up | 4.2 |

Let's suppose that during the execution of a SW Application A, hard disk HD1 has been detected by Monitoring tools to be X seconds in status 1, Y seconds in status 4 and Z seconds in status 5. The Monitoring Agent of the present invention puts together all this information to estimate a total consumption of hard disk HD1 when used by SW Application A. Similar calculations are done for each resource used by SW Application A and a total power consumption for SW Application A is estimated by the system. Each component has an associated table with the description of power consumption related to the component status that can be checked during power measurements.

In any case, notwithstanding the way the power consumption is estimated, this value is provided to the Orchestrator 125 (not shown on FIG. 3). According to a preferred embodiment of the present invention, Tivoli Intelligent Orchestrator product is used. This product automates the traditional, manual provisioning process, performance measurement, capacity planning, and infrastructure deployment. Tivoli Intelligent Orchestrator operates in a closed loop that performs automatic resource requirements prediction, based on predefined service level objectives and agreements and automates infrastructure deployment. This just-in-time cycle ensures that each application has the resource it needs, when it is needed, without static over-provisioning. Based on the above concepts it is possible to introduce the power consumption metrics in Tivoli Intelligent Orchestrator to have workflows taking actions according to power consumption levels and defined thresholds. From an architectural perspective we have two layers in this solution: one layer is the processes balancing system and the other is the Tivoli Intelligent Orchestrator that will take inputs from the balancing system and launch the appropriate actions to optimize the power consumption according to the defined goals. The energy monitoring agent will collect the needed metrics form the monitored resources and will send them to the balancing system that will check for some defined energy policies; then based on the current data, it will send the information to the orchestrator that will take actions in order to meet the energy consumption policies (like add new resources, move jobs, etc.).

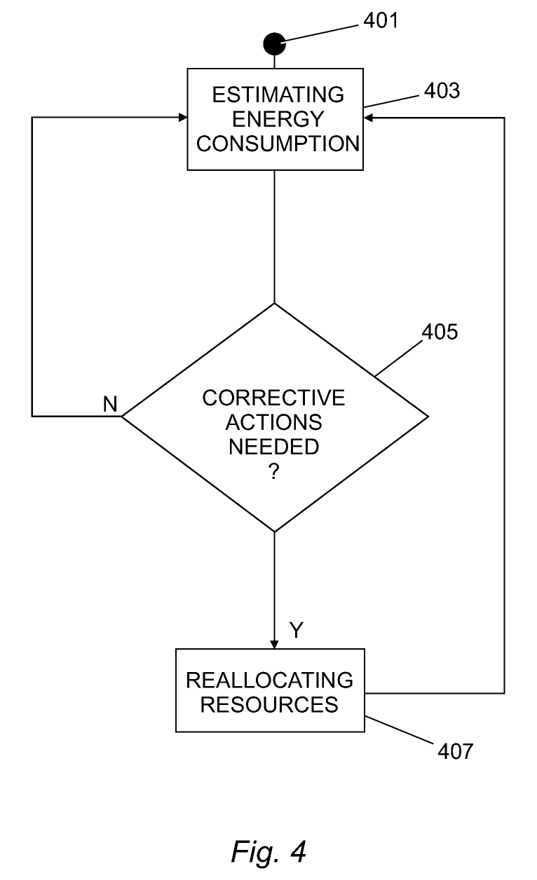

Considering now FIG. 4, the logic flow of generating a product signature according to an embodiment of the invention is represented. The method begins at the black start circle 401. Continuing to block 403 the system is monitored and the consumption of each SW application running on the system is estimated according to the above described methods. At step 405 it is evaluated whether any corrective actions is needed: in case the energy consumption is acceptable, the control goes back to step 403 where the monitoring of the system is performed. This evaluation step can be implemented in many different ways: the simplest one is to compare the result of step 403 with a predetermined thresholds and, if the thresholds is exceeded, invoking a suitable corrective action. The range of corrective actions can vary from a suspension of some activities which are believed to be overconsuming to a complete rebalancing of the resource allocation of the system. According to a preferred embodiment of the present invention an Orchestrator tool is invoked, e.g. the Tivoli Intelligent Orchestrator, which (step 407) reallocates the system resources to optimise the energy consumption. The control then goes back to step 403.

Similar considerations apply if programs and data are structured in a different manner, if other modules or functions are provided, or if the information is stored in equivalent memory structures.

Similar considerations apply if the method includes equivalent or additional steps.

Alternatively, for example different methods of obtaining the information on the monitored resources can be used, depending also on the operating system on which the system is installed.

Although the invention has been described above with a certain degree of particularity with reference to preferred embodiment(s) thereof, it should be understood that various changes in the form and details as well as other embodiments are possible. Particularly, it is expressly intended that all combinations of those elements and/or method steps that substantially perform the same function in the same way to achieve the same results are within the scope of the invention.

In any case, the method of the invention can be used for discovering, inventorying or metering any kind of software products (such as video games, multimedia works, and the like).

In addition, the programs can be distributed on any other computer readable medium (such as one or more DVDs); alternatively, the programs are pre-loaded onto the hard-disks, are transmitted to the computers, are broadcast, or more generally are provided in any other form directly loadable into the working memories of the computers.

Moreover, it will be apparent to those skilled in the art that the additional features providing further advantages are not essential for carrying out the invention, and may be omitted or replaced with different features.

In any case, the method according to the present invention is also suitable to be carried out with a hardware structure (for example, integrated in a chip of semiconductor material), or with a combination of software and hardware.

Naturally, in order to satisfy local and specific requirements, a person skilled in the art may apply to the solution described above many modifications and alterations all of which, however, are included within the scope of protection of the invention as defined by the following claims.

1. A method of provisioning resources in a data processing system including a plurality of resources, each resource having a predefined data sheet defining an associated expected power usage, the method including the steps of:
monitoring the activities of at least one software application running on the data processing system, the at least one software application using at least one of the plurality of resources;
tracking any use of each at least one resource made by the at least one software application;
estimating the power usage of the at least one software application according to the tracked use and the associated expected power usage;
comparing the estimated power usage to a predetermined thresholds;
responsive to the predetermined thresholds being exceeded re-balancing the provisioning of the system resources.

2. The method of claim 1 wherein the predefined data sheet of each resource includes a set of possible status of the resource, each status having an associated expected power usage, the step of tracking including for each tracked use, detecting the status of the resource and the step of estimating is performed also according to the detected status.

3. The method of claim 1 wherein the step of re-balancing includes also infrastructure deployment activities.

4. The method of claim 1 further comprising the steps of:
estimating the power usage of each at least one resource
responsive to the estimated power usage of at least one resource exceeding a predetermined thresholds, applying predefined corrective actions.

5. The method of claim 1 wherein the plurality of resources includes a CPU and a hard disk.

6. A computer program for provisioning resources in a data processing system including a plurality of resources, each resource having a predefined data sheet defining an associated expected power usage performing a method of when the computer program is executed on a data processing system, the method including the steps of:
monitoring the activities of at least one software application running on the data processing system, the at least one software application using at least one of the plurality of resources;
tracking any use of each at least one resource made by the at least one software application;
estimating the power usage of the at least one software application according to the tracked use and the associated expected power usage;
comparing the estimated power usage to a predetermined thresholds;
responsive to the predetermined thresholds being exceeded re-balancing the provisioning of the system resources.

7. (canceled)

8. (canceled)

9. A system for provisioning resources in a data processing system including a plurality of resources, each resource having a predefined data sheet defining an associated expected power usage performing, the system including processor, memory and a computer program for performing the steps of a method when the computer program is executed on the system, the method including the steps of:
monitoring the activities of at least one software application running on the data processing system, the at least one software application using at least one of the plurality of resources;
tracking any use of each at least one resource made by the at least one software application;
estimating the power usage of the at least one software application according to the tracked use and the associated expected power usage;
comparing the estimated power usage to a predetermined thresholds;
responsive to the predetermined thresholds being exceeded re-balancing the provisioning of the system resources.

10. (canceled)
